(19) United States
(12) Patent Application Publication
(10) Pub. No.: US 2015/0008809 A1
(43) Pub. Date: Jan. 8, 2015

(54) CABINET FOR STORING INK-, ENAMEL- AND THE LIKE JET PRINTING MODULES

(71) Applicant: Projecta Engineering S.r.L., Fiorano Modenese (Modena) (IT)

(72) Inventor: Vincenzo Palumbo, Castellarano (RE) (IT)

(21) Appl. No.: 14/369,609

(22) PCT Filed: Nov. 6, 2012
(86) PCT No.: PCT/IB2012/056178

§ 371 Date: Jun. 27, 2014

(30) Foreign Application Priority Data
Dec. 30, 2011 (IT) VR2011A000243

(51) Int. Cl. B41J 29/06; B41J 2/165; B41J 29/377; A47B 81/00

(52) U.S. Cl. CPC B41J 29/06; A47B 81/00; B41J 2/165; B41J 29/377
USPC 312/236

(57) ABSTRACT

A cabinet for storing printing modules with inkjet, enamel and the like, the printing modules being equipped with at least one tank containing ink, enamel and the like and with at least one colour print bar, in turn equipped with at least one digital printing head, the latter provided with a system with multiple nozzles for ejecting colour. The cabinet includes a main box-shaped body, provided with at least closing means, and inside it with at least one seat equipped for housing at least one print module, the cabinet moreover includes an air-conditioning unit for keeping a predetermined temperature and humidity inside the cabinet, the equipped seat making it also possible to periodically actuate the colour bar of the print module, so as to keep the correct state of cleanliness and operation of the printing modules unaltered.

### TECHNICAL FIELD OF THE INVENTION

The present invention concerns a cabinet for storing printing modules of the inkjet, enamel type and the like.

In particular, the present invention concerns a cabinet for storing printing modules of the inkjet, enamel type and the like of the type generally used for decorating, enamelling, or other similar processes to be carried out on ceramic tiles.

### DESCRIPTION OF RELATED ART

In the field of printing, and in particular in that of printing on ceramic tiles, and the like, it is known to use suitable printing devices which comprise printing heads of the inkjet type with different colour inks used to create a wide variety of decoration patterns.

From Italian patent n. 1389755, and from the corresponding European patent n. EP2093065B1, to the same Applicant, it is known to use inkjet printing modules of the type comprising two storage tanks that are located at the same height and that are reciprocally connected in a closed circuit by a delivery line, in which a printing head of the ink is inserted, and by a return line, in which a recycling pump is inserted.

In the printing units according to Italian patent n. 1389755, the ink is kept circulating between the two reservoirs and it is dispensed in a controlled manner from the printing head.

In the prior art, the nozzles of the printing heads forming the colour bar present in the print module are driven by a device for controlling the printing heads themselves, so as to manage the dispensing of ink of a certain colour in the sequence and in the amounts that are required for the decoration: such management is usually localised at the print module, delegating the coordination of the dispensing sequence of the other colour modules to an upper control unit, which is located outside the print module in another section of the decorating machine.

Based upon the decoration to be made, dispensing sequences must be driven that are coordinated by the various colour bars, each of a certain colour: on the decorating machine, the colour bars are usually placed in parallel, in a predetermined succession with respect to the forward direction of the piece to be decorated.

It is often necessary, when the decoration varies, to vary the order of said dispensing sequence of the different colours, such an operation requiring the repositioning of the bars themselves.

It is moreover often necessary, for certain decorations, to add or remove colour bars.

This is rather inconvenient due to a rigid positioning of the bars on the decorating machine, and therefore in order to solve such a problem it has been proposed, in Italian patent application n. RE2011A000012 to the same Applicant, for the printing modules, and the colour bars contained in them, to be made removable and therefore replaced when needed with others having different colour, or with different liquids, for example enamel.

The printing modules that are not used must therefore be replaced in storage areas, for example shelves, containers, etcetera, where they can remain for even relatively long periods of time, which are sufficient for the inks, enamels and the like contained in the printing modules themselves, if the relative printing heads that are part of the relative bar are not removed and suitably cleaned, may coagulate, settle or dry up due to different reasons, for example, to the fact of simply not being used or due to environmental conditions that are not suitable for preserving ink or enamel.

The printing modules therefore quickly become unusable, since they are no longer capable of operating correctly.

It is also clear how the printing modules with degraded ink, and/or with printing heads with obstructed nozzles, even only partially, cause considerable damage in terms of the time needed for re-establishing the normal operation, when this is even possible, and of missed production, and of the respective costs incurred and economic losses.

Moreover, a certain colour can be necessary for some decorations, for others, on the other hand, it may not be necessary to use it. It is therefore frequently necessary to remove and store certain colour bars for periods that may last a short or long time; when more than one decorating machine of the same type is available, it is particularly advantageous to be able to plan the use of a same colour bar alternately on one machine and the other.

### SUMMARY OF THE INVENTION

The technical task of the present invention is to devise a cabinet for storing printing modules that keeps the aforementioned modules in optimal conditions, so that they are immediately ready to be used in relative decorating machines.

Another task of the present invention is that of making a cabinet for storing printing modules with inkjet, enamel and the like, that is simple to use and rapid to use/maintain.

Yet another task of the present invention is to make a cabinet for storing printing modules with inkjet, enamel and the like, which is simple and cost effective even to manage.

A further purpose of the present invention is to allow the temporary relocation and the transportation of each print module from one digital decoration machine to another, if the user has more than one machine.

In accordance with one aspect of the present invention a cabinet is foreseen for storing printing modules with inkjet, enamel and the like according to the present principles.

The description refers to preferred and advantageous embodiments of the invention.

### BRIEF DESCRIPTION OF THE DRAWINGS

Further characteristics and advantages of the invention shall become clearer from the description of some embodiments of the cabinet for storing printing modules with inkjet, enamel and the like, illustrated as an indication in the attached drawing table, in which:

FIG. 1 is a schematic perspective view of the cabinet for storing printing modules with inkjet, enamel and the like, according to the present invention.

### DETAILED DESCRIPTION OF THE INVENTION

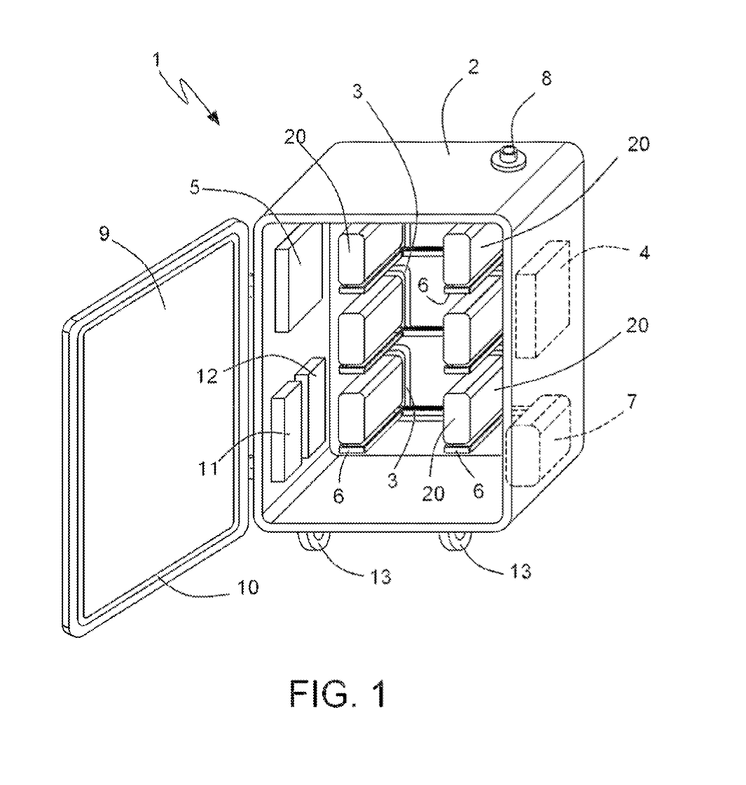

With reference to the attached FIG. 1, reference numeral 1 wholly indicates a cabinet for storing printing modules 20 with inkjet, enamel and the like according to the present invention.

It should be preliminarily noted that by print module 20 we mean a device that is intended for digital printing, usually intended for the management of a single colour at a time, made up of the following elements:

a digital colour bar, in turn made up of one or more digital printing heads, in turn comprising a plurality of dispensing nozzles;
a local electronic control unit, for driving the colour dispensing process from the printing heads;
a local fluid plant, comprising a double tank with recycling system;
a local electric plant, for the local supply of the actuators.

The storing cabinet 1 is of the mobile type, i.e.

it can be positioned where necessary by the user.

The storing cabinet 1 for printing modules 20 with inkjet, enamel and the like, comprises at least one main box-shaped body 2 that is provided, inside it, with at least one seat 3 that is equipped so as to house a respective print module 20, and an air-conditioning unit 4 for maintaining at least the predetermined temperature inside it, so as to preserve the content of each print module 20 and its correct operation.

In the version illustrated in the figures, the storing cabinet 1 comprises a plurality of seats 3 that are equipped for housing respective printing modules 20, and in particular there are six seats for just as many printing modules 20, such a number being mentioned only as an example and therefore should not be taken for limiting purposes.

The cabinet 1 has been devised for storing printing modules 20 of the type comprising two storage tanks that are located at the same height and that are reciprocally connected in a closed circuit by a delivery line, in which a digital decoration bar of the inkjet type is inserted, and by a return line in which a recycling pump is inserted, for example like those described in Italian patent n. 1389755, and in the corresponding European patent n. EP2093065B1.

In such printing modules 20, the ink, or the enamel, or any other liquid with decorating function or the like, is kept circulating between two tanks, and is dispensed in a controlled manner by a printing head with nozzles of the inkjet type.

More in detail, the mentioned equipped seats 3 are electrically supplied so as to allow the operation of the printing modules 20, and are associated with control means 5 to at least control the dispensing of ink, enamel, and the like, from the nozzles of the head which is part of the print module 20 at predetermined time periods, so as to preserve the operation of the dispensing nozzles themselves.

Inside the cabinet 1 it is also foreseen for there to be collection elements 6, like for example tanks, which are each associated with a respective print module 20 for receiving ink or enamel, and the like, dispensed by the print head controlled by the control means 5.

The collection elements 6 are associated with at least one receptacle 7 for collecting ink, enamel and the like, dispensed by the printing modules 20, so as to then be able to easily eliminate it.

The cabinet 1 can comprise a temperature sensor and also a humidity sensor—not represented in the figure—associated with control means 5, for detecting the temperature and the humidity inside the cabinet 1 itself, and the mentioned air-conditioning unit 4 is slaved to the control means 5, for maintaining the predetermined temperature and humidity values that are appropriate for preserving the content of the printing modules 20 and their correct operation.

On the box-shaped body 2 it can be moreover foreseen for there to be a mouthpiece 8 for letting in air that is filtered in overpressure inside the cabinet 1, so as to prevent dust and similar polluting products to enter from outside.

The cabinet 1 can comprise at least one door 9 for sealingly closing the main box-shaped body 2, as visible in FIG. 1, but it can also for example comprise two closing doors. It is also foreseen for there to be a sealing gasket 10 that can be associated with the door 9—as represented in FIG. 1—or with the corresponding coupling edge on the box-shaped body 2.

The cabinet 1 can moreover comprise an electric supply group 11 of its electrical and/or electronic components, and can also comprise an electric continuity group 12 that ensures the correct operation for example following an interruption in the mains current.

The cabinet 1 can moreover comprise displacing means that can be removably locked, like for example lower wheels 13, for the suitable positioning and movement of the cabinet 1 itself in the work place.

In another possible embodiment, not illustrated in the figures, the cabinet 1 can comprise members for topping up the printing modules 20 with ink, enamel and the like, even only partially empty, like for example one or more tanks of ink—also at controlled temperature and humidity—which can be associated with printing modules 20 so as to allow their controlled filling.

The operation of the cabinet 1 for storing printing modules 20 with inkjet, enamel and the like 1, according to the present invention is completely intuitive according to what has been described.

The printing modules 20 are conveniently housed in the climate controlled cabinet 1, coupled with the respective equipped seats 3, at predetermined temperature and humidity values, so as to maintain the ink, enamel and the like contained inside them at optimal conditions, thanks to the mentioned air-conditioning unit 4; moreover, the respective equipped seats 3, which are electrically supplied, allow the printing modules 20 to operate and in particular makes it possible for there to be a continuous recycling of ink, enamel and the like inside them, without it being possible for lumps to be formed and/or for it to dry up.

As mentioned, the control means 5 control the dispensing, at predetermined time periods, of ink, enamel and the like from the nozzles of the printing heads in such a way as to prevent it from drying up thus obstructing the nozzles themselves—which could otherwise occur when they are not used for long periods of time—ensuring in such a way the correct operation of the printing heads themselves.

The temperature and humidity sensors associated with the control means 5 make it possible to always keep the necessary temperature and humidity values inside the cabinet 1 under control to correctly preserve the printing modules 20 and their content.

The invention, thus conceived, makes it possible to obtain important technical advantages.

One important technical advantage is, as it has been seen, made up of the fact that the cabinet according to the present invention makes it possible to maintain the temperature and humidity controlled at values that are suitable for preserving the ink, enamel and the like, contained in the print module 20, preventing it from degrading, drying up or forming lumps, and this for the entire time in which the printing modules 20 themselves remain housed in the cabinet itself.

The cabinet according to the present invention makes it moreover possible to keep the printing heads of the printing modules 20 working perfectly, thanks to the dispensing controlled by the control means of the printing heads, which prevents the nozzles from becoming obstructed.

Furthermore, the equipped seats 3 allow the normal operation of the printing modules 20 of the type for recycling ink, enamel and the like, for the entire time in which they are housed inside the cabinet 1.

It has thus been seen how the invention achieves the proposed purposes.

The present invention has been described according to preferred embodiments, but equivalent variants can be conceived without for this reason departing from the scope of protection offered by the following claims.

1. A cabinet for storing inkjet printing modules, enamel printing modules and the like, said printing modules being provided with at least a tank containing ink, enamel and the like, and with at least a printing bar of the ink-jet type, comprising a main box-shaped body, provided at least with closing means, wherein it comprises inside it at least a seat equipped for housing at least a printing module, and in that it comprises an air-conditioning unit to maintain at least the predetermined temperature inside the cabinet, so as to preserve the content of the printing modules and their proper functioning.

2. The cabinet according to claim 1, wherein said air-conditioning unit comprises means for maintaining the predetermined humidity inside the cabinet.

3. The cabinet according to claim 1, wherein said equipped seats are electrically powered to allow for the operation of the printing modules.

4. The cabinet according to claim 1, wherein said equipped seats are associated with at least control means to control at least the dispensing of ink, enamel and the like, from the printing head nozzles of the printing module at predetermined time intervals, so as to preserve the functionality of the dispensing nozzles.

5. The cabinet according to claim 4, comprising at least a collecting element associated with at least a respective printing module for receiving ink or enamel, and the like, dispensed by the printing head of the printing module controlled by said control means.

6. The cabinet according to claim 5, comprising a plurality of said collecting elements associated with at least a receptacle for collecting ink, enamel and the like, dispensed by the printing heads.

7. The cabinet according to claim 4, comprising at least a temperature sensor associated with said control means for detecting the temperature inside said cabinet.

8. The cabinet according to claim 4, comprising at least a humidity sensor associated with said control means, to detect humidity inside said cabinet.

9. The cabinet according to claim 4, wherein said air-conditioning unit is slaved to said control means, for maintaining the predetermined temperature and/or humidity values suitable for preserving the content of the printing modules and ensuring their proper functioning.

10. The cabinet according to claim 1, comprising at least a mouthpiece for the inlet of overpressure filtered air inside said cabinet, so as to prevent dust and similar pollutants from the outside from entering inside it.

11. The cabinet according to claim 1, comprising at least a door for sealing said main box-shaped body.

12. The cabinet according to claim 11, comprising a sealing gasket which can be associated with said door or with the corresponding coupling edge on the box-shaped body.

13. The cabinet according to claim 1, comprising at least a power supply unit of the electrical and/or electronic components thereof.

14. The cabinet according to claim 1, comprising at least an uninterruptible power supply.

15. The cabinet according to claim 1, comprising displacing means which can be removably locked, for properly locating and displacing said cabinet in the working environment.

16. The cabinet according to claim 1, comprising members for topping up the printing modules, even partially empty, for topping up ink, enamel and the like.
